(19) United States
(12) Patent Application Publication
(10) Pub. No.: US 2023/0009117 A1
(43) Pub. Date: Jan. 12, 2023

(54) PIPE EXTRACTION DEVICE

(71) Applicants: Glen R. Stevick, Berkeley, CA (US); Gershon Perelman, Cupertino, CA (US); Kyle McGrath, Lafayette, CA (US)

(72) Inventors: Glen R. Stevick, Berkeley, CA (US); Gershon Perelman, Cupertino, CA (US); Kyle McGrath, Lafayette, CA (US)

(21) Appl. No.: 17/857,108

(22) Filed: Jul. 4, 2022

Related U.S. Application Data
(60) Provisional application No. 63/220,373, filed on Jul. 9, 2021.

(51) Int. Cl. B25B 27/14

(52) U.S. Cl. CPC B25B 27/14

(57) ABSTRACT

Methods and devices for extracting an internal pipe/tube element from a connected outer pipe/tube element. Certain embodiments are directed to methods and devices that inwardly distort a pipe/tube at a connection to allow the pipe to be more easily disconnected without damaging the overlapping (outside) half of the connection. Collapsing the pipe adjacent to, and into, the fitting and reducing its circumference allows the pipe to be unscrewed or slide out of the overlapping side of the connection. Embodiments are described including partially cutting thru the male portion of the connection and locally compressing and collapsing the pipe to radially disengage it from interior of the opposing fitting or pipe section. In one method, an interior pipe/tube is disengaged from a fitting or overlapping connection where a connection (weld, adhesive or soldered attachment) is utilized and the connection is selected small/weak enough to be broken in the compression process.

### RELATED APPLICATION DATA

This application claims the benefit of U.S. Provisional Application No. 63/220,373 filed Jul. 7, 2021, which is hereby incorporated by reference.

### BACKGROUND

The field of the present disclosure relates to methods and devices for extracting an internal pipe element from a connected outer pipe element.

Today, there are tools to stop flow in or from pipes and hoses by compressing or pinching the pipe or hose. Two patents describing tools that perform these tasks are U.S. Pat. No. 5,273,252 and U.S. Pat. No. 3,260,098. U.S. Pat. No. 3,260,098 also describes squeezing open a deformable metal tube.

The tool described in U.S. Pat. No. 5,273,252 consists of a pair of movable jaws for clamping and crimping a pipe. The tool described in U.S. Pat. No 3,260,098 uses a die to obtain the desired shape of the pipe.

There are also patents describing a wrench or other device that grips the internal surface of a pipe to be turned, for example U.S. Pat. No 6,675,679 and U.S. Pat. No 1,492,466.

These existing devices do not readily extract an inner pipe or tube element from the connected outer pipe or tube element (e.g., a connecting fitting) without irreparably damaging the connecting fitting or overlapping/outer pipe or tube element.

### SUMMARY

The present disclosure relates to pipe extraction devices and methods. Certain embodiments are directed to compressing devices and methods that inwardly distort an inner pipe or tube element at an outer connected pipe or tube element (e.g., a connected fitting) to allow the inner pipe element to be more easily disconnected without damaging the outer/overlapping pipe element or fitting. The method and devices may be used in many fields, including plumbing to retrofit a piping or tubing system where the female fitting or overlapping half of the connection is reused. Corrosion, friction, adhesive, welding and/or soldering at a fitting can make it difficult or impossible to remove the pipe without irreparably damaging the fitting or overlapping (outside) half of the connection.

### BRIEF DESCRIPTION OF THE DRAWINGS

FIG. 1 is an exploded isometric view of a pipe extraction device without the piping according to an embodiment;

FIG. 2 is an exploded isometric view of a pipe compressing device with the exterior displayed in a transparent manner, allowing the interior to be viewed;

FIG. 3 is an isometric view of a pipe compressing device including an illustrative embodiment of a pipe that is to be removed;

FIG. 4 is a front view of a pipe compressing device with the pipe in the locally compressed and collapsed condition;

FIG. 5 is an exploded isometric view of a pipe compressing device and an attachment pipe cutting (slotting) tool;

FIG. 6 is an isometric view of a pipe compressing device with the attachment pipe cutting (slotting) tool in place;

FIG. 7 is an isometric view of a pipe cutter (slotting) tool;

FIG. 8 is an exploded front view of a second embodiment of a pipe compressing device where the compressing appendage moves separately from the bridge component;

FIG. 9 is an exploded transparent isometric view of a second embodiment of a pipe compressing device;

FIG. 10 is an isometric view of a second embodiment of a pipe compressing device installed on a pipe;

FIG. 11 is a front view of a second embodiment of the pipe compressing device installed on a pipe;

FIG. 12 is an isometric view of a second embodiment of the pipe compressing device in use with the pipe in the compressed condition.

### DETAILED DESCRIPTION

Certain embodiments will now be described more fully with reference to the accompanying drawings.

Certain embodiments may create a simple and convenient method for extracting or disconnecting a pipe at a screwed or overlapping connection that is inhibited from sliding or rotating apart in the usual manner. Corrosion, friction and/or seal welding at a screwed or other connected fitting (e.g., welded, adhesive, soldered) can make fittings, pipes and tubes difficult or impossible to separate. Certain methods and extracting devices described herein may inwardly compress a pipe or tube at a connection to allow the pipe to be disconnected without damaging the overlapping (outside) half of the connection. Collapsing the pipe adjacent to, and into, the fitting and reducing its circumference may allow the pipe to be unscrewed or slide out of the overlapping side of the connection. Various embodiments may include partially cutting thru the male portion of the connection and locally compressing and collapsing the pipe to radially disengage it from the interior of the opposing fitting or pipe section. Certain extraction methods may be used to disengage an interior pipe or tube from a fitting or overlapping connection where a weld, adhesive or soldered attachment was utilized and the weld, adhesive or solder is small or weak enough to be broken in the compression process.

This method of extracting or disconnecting a pipe at a screwed or overlapped connection by inwardly collapsing the pipe can be achieved by any tool, or combination of tools, which can be used to collapse a pipe wall. For example, a hammer and chisel can be employed to compress or collapse small pipes such as those used in plumbing. For large pipes, such as city water supply pipes, a demolition hammer or sledgehammer can be employed to a similar effect. Cutting tools such as a hacksaw or angle grinder can be used to reduce the length of the pipe and cut slots to aid in collapsing the pipe as described above. The embodiments described provide a simple and convenient method for extracting or disconnecting a pipe at a screwed or overlapping connection.

Certain embodiments may be used in plumbing applications where a pipe (e.g., externally threaded) needs to be removed from a fitting (e.g., internally threaded) where the threads are rusted together and it is desirable to save and reuse the fitting and piping on the opposite side from the piping to be removed. An embodiment may locally compress the externally threaded pipe to be removed and reduce its effective circumference, whereby the external threads may be pulled radially inward and away from the internal threads in the fitting allowing the pipe to be separated from the fitting by sliding and/or rotating, whereby the fitting would remain undamaged and available for reuse.

In one embodiment, a U-section pipe housing component is configured for one or more pipe sizes. A bridge component connected to the open end of the U-section with two bolts is moved toward the U-section by the same bolts which forces the bridge section appendage into the pipe, locally compressing and collapsing the pipe. This compression reduces the effective circumference of the pipe, allowing it to be removed from the internally threaded fitting. A slot may be cut in the pipe to more easily collapse the pipe when the compressing device is placed between the slot and fitting. The bolts may suitably be replaced by hydraulic, pneumatic or electric actuators to pull the bridge and U-section components together or drive a compressing (crushing) tip into the pipe where frame components are stationary.

In other embodiments, the bridge section may be attached to the U-section with bolts, hinge and clasp or other suitable attachment method. The appendage is driven or forced into the pipe with a separate screw or actuator (hydraulic, pneumatic or electric). Thereby accomplishing the same result, locally compressing and collapsing the pipe so that it pulls radially inward and away from the internal surface of the fitting or overlapping half of the connection.

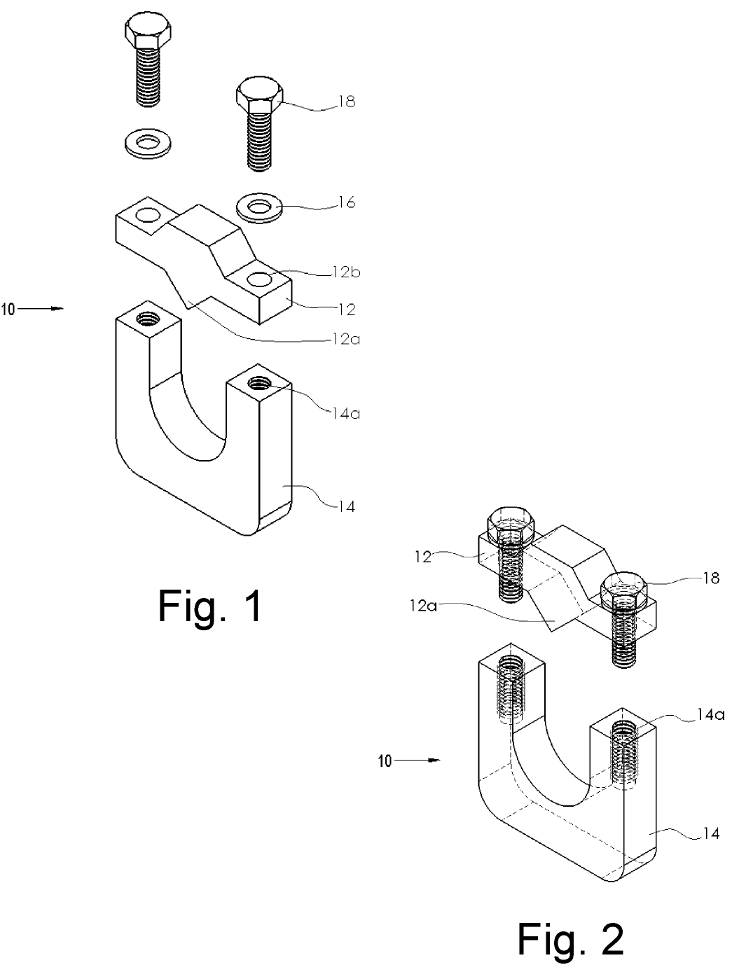

FIG. 1 is an exploded view of a pipe extraction device 10 according to an embodiment. The pipe extraction device 10 comprises two sections: the bridge section 12 with a large appendage 12a and the lower U-section 14. Each hex head screw 18 may pass through a washer 16 to distribute pressure and protect the surface on the bridge section 12. The hex head screw passes through the holes 12b in the bridge section 12 before being threaded into the threaded holes 14a in the U-section 14.

FIG. 2 is a transparent view of the pipe extraction device 10. The threaded holes 14a are designed such that when the hex head screw 18 is completely screwed in, the bridge section 12 is in the furthest closed position and the appendage 12a has collapsed a pipe that the device is installed on.

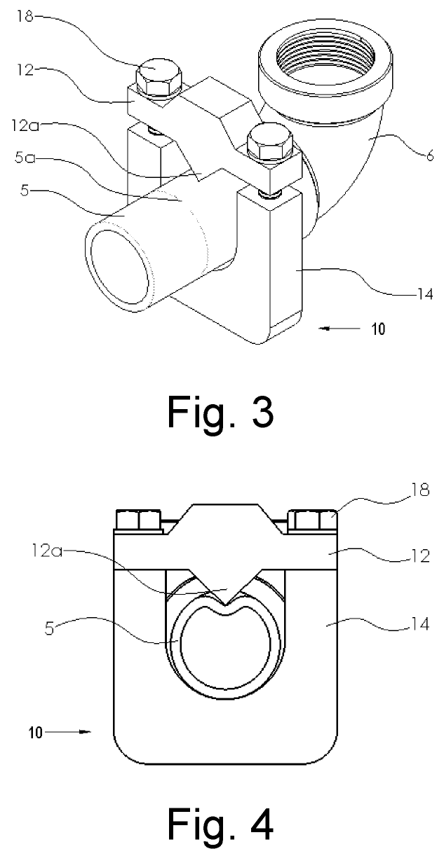

FIG. 3 shows the pipe extraction device 10 in the open position and installed on a pipe 5. Pipe 5 is a pipe that is attached to a pipe fitting 6. In some applications the pipe 5 and fitting 6 are rusted (or bonded) together, preventing the removal of the pipe 5 from the female fitting 6. The upper bridge section 12 is not assembled until the U-section 14 is placed around the pipe 5. Line 5a represents the location where the pipe 5 can be cut with a hacksaw or other suitable cutting tool before the pipe extraction device is placed onto the pipe adjacent to the internally threaded fitting. Pipe 5 should be cut in such a way that the cut is as close to the side of pipe extraction device 10 as possible while still allowing the pipe extraction device to fit between the cut and fitting. To use the pipe extraction device 10, the user employs a wrench or other torque providing tool (pneumatic, hydraulic or electric nut driver) to tighten the hex head screws 18 until the screws are fully or partially screwed into the threaded holes 14a and the pipe 5 is crushed. It should be noted that studs mounted into the U-section 14 with corresponding nuts may replace the hex head bolts 18. The dimensions of bridge section 12 and U-section 14 are dependent on the diameter of pipe 5 and may be constructed to work on one or more pipe sizes.

FIG. 4 is a front facing view of the pipe extraction device 10 in the closed position. The hex head screws 18 are completely screwed into threaded holes 14a and the pipe extraction device is in the fully closed or locally compressing position. The appendage 12a of the bridge section 12 is at its lowest radial position relative to the centerline of the pipe 5.

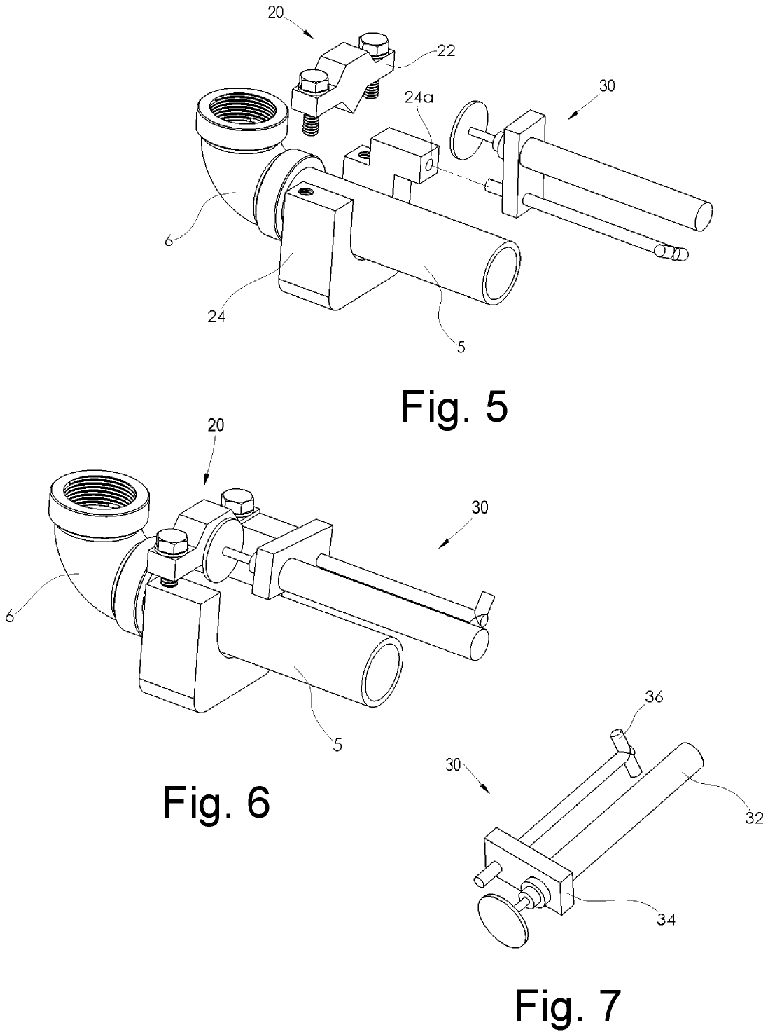

FIGS. 5 and 6 are alternate embodiments of the pipe extraction device 20 with an attachment point 24a for a cutting tool 30. The attachment point 24a holds the cutting tool to allow it to have free motion to move down and cut the pipe 5.

FIG. 7 is an isometric view of the alternate embodiment cutting tool 30. The example cutting tool 30 comprises an off-the-shelf rotary tool 32 which is held by a mount 34 that holds the rotary tool the proper distance away from the attachment point. The attachment 36 goes through the rotary tool mount 34 in order to attach to attachment point 24a (FIGS. 5 and 6). The rotary tool depicted can be replaced by a wide variety of off-the-shelf or custom-made cutting tools and mountings to produce an equivalent embodiment. The rotary tool may be powered electrically, hydraulically, or pneumatically.

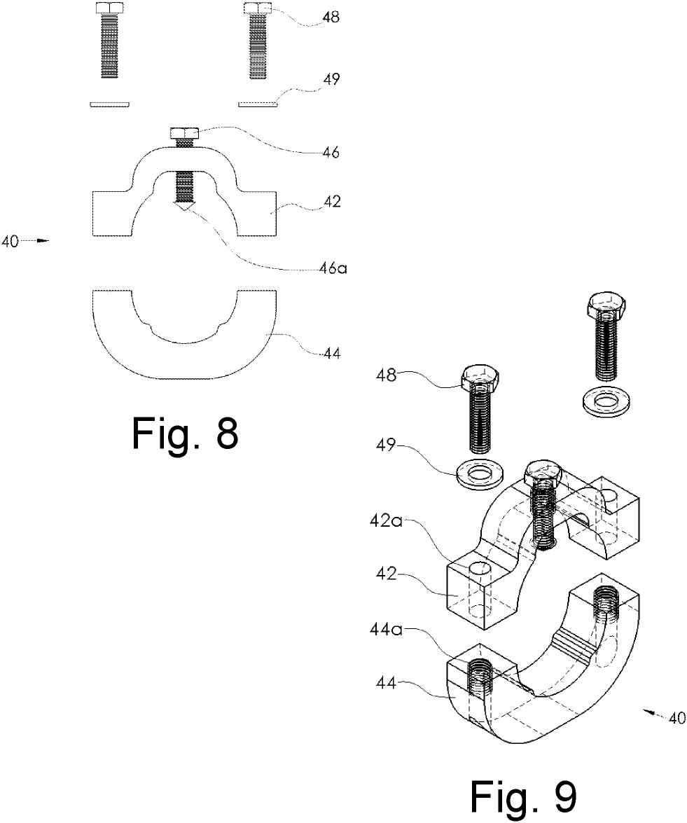

FIG. 8 is a front facing exploded view of the second embodiment pipe extraction device 40. This second embodiment comprises two or more arc-sections where one or more sections 42 comprises a compressing head screw 46 and one or more sections 44 complete the encirclement of the pipe (do not contain a compressing head screw). Encirclement of the pipe may also be completed with only sections 42 containing provision for a compressing screw and/or having a compressing screw 46. The large appendage in the previous embodiment has been replace with a compressing hex head screw 46 adapted for crushing pipe. The compressing hex screw 46 has a modified crushing tip 46a where the hex head screw or crushing tip may have a rotational slip element that allows the crushing tip to not rotate as the screw is rotated. The dimensions of bridge sections 42 and 44 are dependent on the diameter of pipe being crushed and may be constructed to work on one or more pipe sizes.

FIG. 9 is a transparent exploded isometric view of the second embodiment of the pipe extraction device 40. Each screw 48 may pass through a washer 49 to distribute pressure and protect the surface on the bridge section 42. The hex head screws 48 pass through the holes 42a in the bridge section 42 before being threaded into the threaded holes 44a in the U-section 44.

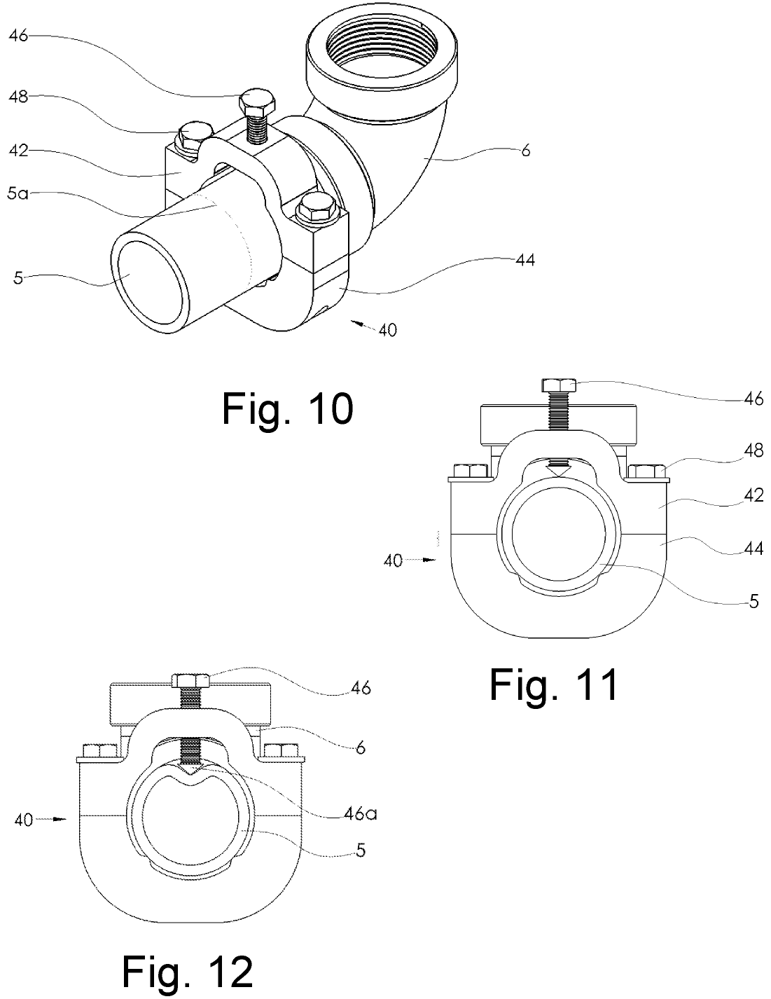

FIG. 10 shows an isometric view of the second embodiment of the pipe extraction device 40 installed on a pipe. Pipe 5 is a pipe that is attached to a pipe fitting 6. In some circumstances the pipe 5 and fitting 6 are rusted together, preventing the removal of the pipe 5 from the fitting 6. Line 5a represents the location where pipe 5 can be cut or scored with a hacksaw or other cutting tool before the pipe extraction device is placed onto the pipe adjacent to the internally threaded fitting. Pipe 5 should be cut in such a way that the cut is as close to the side of pipe extraction device 40 as possible while still allowing the pipe extraction device to fit between the cut and fitting. To use the pipe extraction device 40, the user employs a wrench or other torque providing tool (pneumatic, hydraulic, or electric nut driver) to tighten the hex head screws 48 until they are fully screwed into the threaded holes 44a. The compressing screw 46 is then torqued until the pipe 5 is crushed. Once crushed, the connection between pipe 5 and fitting 6 will be loosened allowing them to be separated easily. It should be noted that studs with corresponding nuts could replace the bolts connecting the bridge sections. The dimensions of arc or bridge sections 42 and 44 are dependent on the diameter of pipe 5 and may be constructed to work on one or more pipe sizes.

FIG. 11 shows a front view of the second embodiment of the pipe crushing device 40 in the open position. The hex head screws 48 are completely fastened into threaded holes 44a connecting bridge sections 42 and 44. The compressing screw 46 has not yet been torqued on the pipe 5. The compressing screw 46 could have a variety of head configurations to allow to torque to be applied; examples include a slot or hole for an attaching bar or rod, hex, square and star (internal and external) shapes to allow for the application of an internal or external fitting wrench.

FIG. 12 shows a front facing view of the second embodiment of the pipe crushing device 40 in the closed position. The compressing hex head screw 46 has been torqued downward causing the crushing tip 46a to locally collapse the wall of pipe 5. Collapsing the pipe wall will disengage the bond between pipe 5 and fitting 6 allowing them to be separated easily.

A method may also be applied to large pipe where an encircling clamp device may be impractical due to size, position and/or cost. The pipe may be locally slotted near the fitting with a saw, torch or other cutting means and then the pipe locally collapsed with an applied force between the slot and fitting causing inwardly the male pipe end in inwardly pull away from the fitting to facilitate removal of the pipe from the fitting.

1. A method for extracting an internal pipe element from a connected outer pipe element, comprising the steps of:
radially collapsing the internal pipe element at one or more locations around a circumference proximate the outer pipe element thereby reducing an effective radius of the internal pipe element;
sliding or rotating the internal pipe element out of the outer pipe element.

2. A method for extracting according to claim 1, wherein radially collapsing the internal pipe element comprises breaking a connection between the internal pipe element and the connected outer pipe element.

3. A method according to claim 1 where the external pipe element comprises a female threaded pipe fitting and the internal pipe element comprises male threaded pipe.

4. A method according to claim 1 wherein the internal pipe element is connected to the external pipe element via a connection selected from the group consisting of: a threaded connection, swage connection, a soldered connection, a compression connection, an adhesive connection.

5. A method according to claim 1 wherein the internal pipe element and the outer pipe element are connected via an adhesive connection, wherein the step of radially collapsing facilitates breaking of the adhesive connection.

6. A method according to claim 1 further comprising
cutting a slot in the internal pipe element proximate the outer pipe element.

7. An extraction device that enables the removal of an internal pipe element from a connected external pipe element, comprising
a compression device having a U-shaped section configured to accept and at least partially encircle a first side of the internal pipe element to be extracted, the compressing device having a bridge section that extends across an opening of the U-section and is movable into contact with a second side of the internal pipe element opposite the U-shaped section and proximate the external pipe element,
wherein the compression device is operative to move the bridge section into the internal pipe element, thereby compressing the internal pipe element between the bridge section and the U-shaped section.

8. An extraction device according to claim 7 wherein the compression device comprises two or more bolts to combine the bridge section and U-shaped section, encircling the internal pipe element, wherein the bridge section comprises an appendage pointing into the internal pipe element, wherein tightening of the bolts radially forces the appendage of the bridge section into the internal pipe element.

9. An extraction device according to claim 7 further comprising a cutting device attached to the compression device.

10. An extraction device according to claim 8 wherein the bolts comprise studs and nuts.

11. An extraction device for extracting an internal pipe element from a connected outer pipe element, comprising
a compressive device having a bottom holder section for receiving the internal pipe element proximate the outer pipe element, the compressive device having a bridge section impinging upon the internal pipe element opposite the bottom holder section,
wherein the bridge section is movable toward the bottom holder section for collapsing the inner pipe element within the outer pipe element thereby enabling the internal pipe element to be removed from the outer pipe element.

12. An extraction device according to claim 11 wherein the compression device comprises two or more bolts to combine the bottom holder section and bridge section, encircling the internal pipe element, wherein the bridge section comprises one or more appendages pointing into the internal pipe element, wherein tightening of the bolts radially forces the appendage of the bridge section into the internal pipe element.

13. An extraction device according to claim 11 further comprising a cutting device attached to the pipe compression device.

14. An extraction device according to claim 12 wherein the bolts comprise studs and nuts.

15. An extraction device that enables the removal of an internal pipe element from a connected external pipe element, comprising
a compression device comprising
a U-shaped section configured to accept and at least partially encircle a first side of the internal pipe element to be extracted,
a bridge section that extends across an opening of the U-section encircling a second side of the internal pipe element to be extracted, and
a radial screw centered in the bridge section which can be tightened to contact the internal pipe element,
wherein the compression device is operative to move the radial screw into the internal pipe element, thereby compressing the internal pipe element between an appendage on the radial screw and the U-shaped section.

16. An extraction device according to claim 15 wherein the compression device further comprises two or more bolts operative to combine the U-shaped section and bridge section, encircling the internal pipe element, wherein the bridge section engages the radial screw pointing into the internal pipe element, wherein tightening of the radial screw forces a tip of the radial screw into the internal pipe element.

17. An extraction device according to claim 15 further comprising a pneumatic, hydraulic, or electronic actuator operative to push the appendage of the radial screw into the internal pipe element and locally collapse the internal pipe element.

18. An extraction device according to claim 15 further comprising a cutting device attached to the pipe compression device.

19. An extraction device according to claim 16 wherein the bolts comprise studs and nuts.

20. An extraction device that enables removal of an internal pipe element from a connected external pipe element, comprising
a compression device having at least first and second shallow arc-shaped sections which combine to encircle the internal pipe element to be extracted, the compressing device having a radial screw centered in one or more of the arc-shaped sections, wherein the radial screw is operative to be tightened to contact the internal pipe element,
wherein the compression device is operative to move the radial screw into the internal pipe element, thereby compressing the internal pipe element between an appendage on the radial screw and the shallow arc-shaped sections.

21. An extraction device according to claim 20 wherein the compression device comprises two or more bolts to combine the shallow arc-shaped sections, encircling the internal pipe element, wherein one or more shallow arc-shaped sections comprises the radial screw pointing into the internal pipe element, wherein tightening of the radial screw forces the appendage on the radial screw into the internal pipe element.

22. An extraction device according to claim 20 further comprising an actuator operative to push the appendage on the radial screw into the internal pipe element and locally collapse the internal pipe element.

23. An extraction device according to claim 20 further comprising a cutting device attached to the compression device.

24. An extraction device according to claim 21 wherein the bolts comprise studs and nuts.

25. An extraction device according to claim 20 wherein the appendage on the radial screw comprises a rotational slip element that allows the appendage to not rotate as the radial screw is rotated.

26. A method of removing a threaded male pipe section from an outer connected female pipe fitting, comprising the steps of
forming a cut in the male pipe section proximate the female pipe fitting;
inwardly collapsing the male pipe section between the cut and the female pipe fitting to inwardly retract the male pipe section away from the female pipe fitting to facilitate removal of the male pipe section from the female pipe fitting.
